(19) United States
(12) Patent Application Publication
(10) Pub. No.: US 2025/0140271 A1
(43) Pub. Date: May 1, 2025

(54) SILENCE DESCRIPTOR USING SPATIAL PARAMETERS

(71) Applicant: NOKIA TECHNOLOGIES OY, Espoo (FI)

(72) Inventors: Anssi Sakari RÄMÖ, Tampere (FI); Mikko-Ville LAITINEN, Espoo (FI); Adriana VASILACHE, Tampere (FI); Lasse Juhani LAAKSONEN, Tampere (FI)

(73) Assignee: NOKIA TECHNOLOGIES OY, Espoo (FI)

(21) Appl. No.: 18/687,871

(22) PCT Filed: Aug. 30, 2021
(86) PCT No.: PCT/FI2021/050584

§ 371 Date: Feb. 29, 2024

(51) Int. Cl. G10L 19/012; G10L 19/008; G10L 19/032

(52) U.S. Cl. CPC G10L 19/012; G10L 19/008; G10L 19/032

(57) ABSTRACT

There is inter alia disclosed an apparatus for spatial audio encoding configured to: determine an error of fit measure (408) between a plurality of spatial direction component values (402) from a plurality of audio frames and a curve fitted (405) to a data set comprising the plurality of spatial direction component values; compare the error of fit measure to a threshold value; and depending on the comparison, either use a method of non-prediction for generating at least one spatial direction component value for each remaining audio frame of the interval of audio frames, or use a method of prediction for generating the at least one spatial direction component (406) value for each remaining audio frame of the interval of audio frames.

### FIELD

The present application relates to apparatus and methods for spatial audio encoding. In particular the encoding of silence descriptor update frames using spatial audio parameters during a DTX period.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and for example a stereo or mono signal can be generated from the microphone array signals to be conveyed with the spatial metadata. The stereo signal could be encoded, for example, with an AAC encoder and the mono signal could be encoded with an EVS encoder. A decoder can decode the audio signals into PCM signals and process the sound in frequency bands (using the spatial metadata) to obtain the spatial output, for example a binaural output.

Voice Activity Detection (VAD), also known as speech activity detection or more generally as signal activity detection is a technique used in various speech processing algorithms, most notably speech codecs, for detecting the presence or absence of human speech. It can be generalized to detection of active signal, i.e., a sound source other than background noise. Based on a VAD decision, it is possible to utilize, e.g., a certain encoding mode in a speech encoder.

Discontinuous Transmission (DTX) is a technique utilizing VAD intended to temporarily shut off parts of active signal processing (such as speech coding according to certain modes) and the frame-by-frame transmission of encoded audio. For example, rather than transmitting normal encoded frames infrequent simplified update frames are sent to drive a comfort noise generator (CNG) at the decoder. The use of DTX can help with reducing interference and/or preserving/reallocating capacity in a practical mobile network. Furthermore, the use of DTX can also help with battery life of the device, e.g., by turning off radio when not transmitting.

Comfort Noise Generation (CNG) is a technique for creating a synthetic background noise at the decoder to fill silence periods that would otherwise be observed. For example, comfort noise generation can be implemented under a DTX operation.

Silence Descriptor (SID) frames can be sent during speech inactivity to keep the receiver CNG decently well aligned with the background noise level at the sender side. This can be of particular importance at the onset of each new talk spurt. Thus, SID frames should not be too old, when speech starts again. Commonly SID frames are sent regularly, e.g., every 8th frame, but some codecs allow also variable rate SID updates. SID frames are typically quite small, e.g., 2.4 kbit/s SID bitrate equals 48 bits per frame. However, prior art SID frames are derived for mono based audio processing systems such as those commonly found in most speech codecs. The use of SID frames with parametric spatial audio systems such as IVAS is not known.

### SUMMARY

There is according to a first aspect a method for spatial audio signal encoding comprising: determining an error of fit measure between a plurality of spatial direction component values from a plurality of audio frames and a curve fitted to a data set comprising the plurality of spatial direction component values; comparing the error of fit measure to a threshold value; quantising a spatial direction component value for a first audio frame of an interval of audio frames to give a quantised spatial direction component value for the first audio frame; and depending on the comparison, either use a method of non-prediction for generating at least one spatial direction component value for each remaining audio frame of the interval of audio frames, or use a method of prediction for generating the at least one spatial direction component value for each remaining audio frame of the interval of audio frames, wherein all remaining audio frames comprise all but the first audio frame of the interval of audio frames.

The method of non-prediction for generating the at least one spatial direction component value for each remaining audio frame of the interval of audio frames may comprise storing the quantised spatial direction component value of the first audio frame for use as a previous quantised spatial direction component value.

The method of prediction for generating the at least one spatial direction component value for each remaining audio frame of the interval of audio may comprise determining whether the interval of audio frames is a first interval of audio frames of a silence region of the spatial audio signal or whether the interval of audio frames is a further interval of audio frames of the silence region of the spatial audio signal.

If the interval of audio frames may be determined as the first interval of audio frames of the silence region of the spatial audio signal, the method may further comprise: determining the coefficients of a backward predictor using a data set comprising a plurality of quantised spatial direction component values drawn from the plurality of audio frames; initialising the backward predictor with the quantised spatial direction component value for the first audio frame of the interval of audio frames; and using the backward predictor to predict the at least one spatial direction component value for each remaining audio frame of the first interval of audio frames of the silence region.

The backward predictor may be a first order backward predictor, and wherein the coefficients of the backward predictor may be determined using least mean square analysis of the data set comprising the plurality of average spatial direction component values drawn from the plurality of audio frames.

If the interval of audio frames may be determined as the further interval of audio frames of the silence region of the spatial audio signal, the method may further comprise: using linear interpolation to interpolate between the quantised spatial direction component value for the first audio frame of the further interval of audio frames of the silence region and a previous quantised spatial direction component value for a first audio frame from a previous interval of audio frames of the silence region; extrapolating the linear interpolation to extend over remaining audio frames of the further interval of audio frames; and assigning at least one value from along the extrapolated part of the liner interpolation for each remaining audio frame of the further interval of audio frames, wherein the assigned at least one value is the at least one spatial direction component value for the each remaining audio frame of the further interval of audio frames.

Determining an error of fit measure between a plurality of spatial direction component values from the plurality of audio frames and the curve fitted to a data set comprising the plurality of spatial direction component values may comprise: performing least mean squares analysis on the data set comprising the plurality of spatial direction component values to find coefficients for a polynomial for curve fitting to the data set; determining for each spatial direction value of the plurality of spatial direction component values an error value between the each spatial direction component value and a point of the curve fitted to the data set; and determining the error of fit measure as the root mean square of the error values.

The polynomial for curve fitting to the data set may be a first order polynomial.

The curve fitted to the data set comprising the plurality of spatial direction component values may be the linear interpolation between the quantised average spatial direction component value for the first audio frame of the further interval of audio frames of the silence region and a previous quantised average spatial direction component value for the first frame from the previous interval of audio frames of the silence region, and wherein the plurality of spatial direction component values may be original spatial direction components values for the previous interval of audio frames, then determining an error of fit measure between a plurality of spatial direction values from a plurality of audio frames and a curve fitted to a data set comprising the plurality of spatial direction values may comprise: determining for each spatial direction value of the plurality of spatial direction component values an error value between the each spatial direction component value and a point along the is the linear interpolation; and determining the error of fit measure as the root mean square of the error values.

The first audio frame of the interval audio frames may comprise a plurality of subframes, wherein each of the plurality of subframes may comprise a spatial direction component value and wherein the spatial direction component value may be an average spatial direction component value comprising the mean of the plurality of subframe spatial direction component values, and the quantised spatial direction component value may be a quantised average spatial direction component value.

A spatial direction component value may be related to a spatial direction parameter, wherein the spatial direction parameter comprises an azimuth component and an elevation component, and wherein the spatial direction component value may be one of: an x-cartesian component transformed from the azimuth component and elevation component; a y-cartesian component transformed from the azimuth component and elevation component; and a z-cartesian component transformed from the azimuth component and elevation component.

The plurality of audio frames may comprise audio frames prior to the first audio frame of the interval of audio frames.

The plurality of audio frames may comprise the first audio frame of the interval of audio frames and audio frames prior to the first audio frame of the interval of audio frames.

The determination of use of prediction or non-prediction may be signalled as a 1-bit flag.

The interval of audio frames may be a silence descriptor (SID) interval.

There is according to a second aspect a method for spatial audio signal decoding comprising: receiving a quantised spatial direction component value for a first audio frame of an interval of audio frames; determining whether to use a method of non-prediction for generating at least one spatial direction component value for each remaining frame of the interval of audio frames, wherein all remaining audio frames comprise all but the first audio frame of the interval of audio frames; and determining whether to use a method of prediction for generating at least one spatial direction component value for each remaining frame of the interval of audio frames, wherein all remaining audio frames comprises all but the first audio frame of the interval of audio frames.

The method of non-prediction for generating a spatial direction component value for each remaining frame of the interval of audio frames may comprise: using the received quantised spatial direction component value for the first audio frame of the interval of audio frames as at least one spatial direction component value for each of the remaining frames of the interval of audio frames.

The method of prediction for generating the at least one spatial direction component value for each remaining frame of the interval of audio frames may comprise: determining whether the interval of audio frames is a first interval of audio frames of a silence region of the spatial audio signal or whether the interval of audio frames is a further interval of audio frames of the silence region of the spatial audio signal.

If the interval of audio frames is determined as the first interval of audio frames of the silence region of the spatial audio signal, the method may further comprise: determining coefficients of a backward predictor using a data set comprising a plurality of quantised spatial direction component values drawn from a plurality of audio frames; initialising the backward predictor with the quantised spatial direction component value for the first audio frame of the interval of audio frames; and using the backward predictor to predict the at least one spatial direction component value for each remaining frame of the first interval of audio frames of the silence region.

The backward predictor may be a first order backward predictor, and wherein the coefficients of the backward predictor maybe determined using least mean square analysis of the data set comprising the plurality of quantised spatial direction component values drawn from the plurality of audio frames.

If the interval of audio frames is determined as the further interval of audio frames of the silence region of the spatial audio signal, the method may further comprise: using linear interpolation to interpolate between the quantised spatial direction component value for the first audio frame of the further interval of audio frames of the silence region and a previous quantised spatial direction component value for a first audio frame from a previous interval of audio frames of the silence region; extrapolating the linear interpolation to extend over remaining audio frames of the further interval of audio frames; and assigning at least one value from along the extrapolated part of the liner interpolation for each remaining audio frame of the further interval of audio frames, wherein the assigned at least one value is the at least one spatial direction value for the each remaining audio frame of the further interval of audio frames.

The determination of use of prediction or non-prediction may comprise: receiving a flag signalling the use of prediction or non-prediction; and reading the received flag.

The spatial direction component value may be related to a spatial direction parameter, wherein the spatial direction parameter comprises an azimuth component and an elevation component, and wherein the spatial direction component value may be one of: an x-cartesian component transformed from the azimuth component and elevation component; a y-cartesian component transformed from the azimuth component and elevation component; and a z-cartesian component transformed from the azimuth component and elevation component.

The interval of audio frames may be a silence descriptor (SID) interval.

There is according to a third aspect an apparatus for spatial audio signal encoding configured to: determine an error of fit measure between a plurality of spatial direction component values from a plurality of audio frames and a curve fitted to a data set comprising the plurality of spatial direction component values; compare the error of fit measure to a threshold value; quantise a spatial direction component value for a first audio frame of an interval of audio frames to give a quantised spatial direction component value for the first audio frame; and depending on the comparison, either use a method of non-prediction for generating at least one spatial direction component value for each remaining audio frame of the interval of audio frames, or use a method of prediction for generating the at least one spatial direction component value for each remaining audio frame of the interval of audio frames, wherein all remaining audio frames comprise all but the first audio frame of the interval of audio frames.

The method of non-prediction for generating the at least one spatial direction component value for each remaining audio frame of the interval of audio frames may comprise the apparatus to be configured to store the quantised spatial direction component value of the first audio frame for use as a previous quantised spatial direction component value.

The method of prediction for generating the at least one spatial direction component value for each remaining audio frame of the interval of audio may comprise the apparatus to be configured to determine whether the interval of audio frames is a first interval of audio frames of a silence region of the spatial audio signal or whether the interval of audio frames is a further interval of audio frames of the silence region of the spatial audio signal.

If the interval of audio frames is determined as the first interval of audio frames of the silence region of the spatial audio signal, the apparatus may be further configured to: determine the coefficients of a backward predictor using a data set comprising a plurality of quantised spatial direction component values drawn from the plurality of audio frames; initialise the backward predictor with the quantised spatial direction component value for the first audio frame of the interval of audio frames; and use the backward predictor to predict the at least one spatial direction component value for each remaining audio frame of the first interval of audio frames of the silence region.

The backward predictor may be a first order backward predictor, and the coefficients of the backward predictor may be determined using least mean square analysis of the data set comprising the plurality of average spatial direction component values drawn from the plurality of audio frames.

If the interval of audio frames is determined as the further interval of audio frames of the silence region of the spatial audio signal, the apparatus may be further configured to: use linear interpolation to interpolate between the quantised spatial direction component value for the first audio frame of the further interval of audio frames of the silence region and a previous quantised spatial direction component value for a first audio frame from a previous interval of audio frames of the silence region; extrapolate the linear interpolation to extend over remaining audio frames of the further interval of audio frames; and assign at least one value from along the extrapolated part of the liner interpolation for each remaining audio frame of the further interval of audio frames, wherein the assigned at least one value is the at least one spatial direction component value for the each remaining audio frame of the further interval of audio frames.

The apparatus configured to determine an error of fit measure between a plurality of spatial direction component values from the plurality of audio frames and the curve fitted to a data set comprising the plurality of spatial direction component values may be configured to: perform least mean squares analysis on the data set comprising the plurality of spatial direction component values to find coefficients for a polynomial for curve fitting to the data set; determine for each spatial direction value of the plurality of spatial direction component values an error value between the each spatial direction component value and a point of the curve fitted to the data set; and determine the error of fit measure as the root mean square of the error values.

The polynomial for curve fitting to the data set may be a first order polynomial.

The curve fitted to the data set comprising the plurality of spatial direction component values may be the linear interpolation between the quantised average spatial direction component value for the first audio frame of the further interval of audio frames of the silence region and a previous quantised average spatial direction component value for the first frame from the previous interval of audio frames of the silence region, wherein the plurality of spatial direction component values may be original spatial direction components values for the previous interval of audio frames, the apparatus configured to determine an error of fit measure between a plurality of spatial direction values from a plurality of audio frames and a curve fitted to a data set comprising the plurality of spatial direction values maybe configured to: determine for each spatial direction value of the plurality of spatial direction component values an error value between the each spatial direction component value and a point along the is the linear interpolation; and determine the error of fit measure as the root mean square of the error values.

The first audio frame of the interval audio frames may comprise a plurality of subframes, wherein each of the plurality of subframes may comprise a spatial direction component value and wherein the spatial direction component value may be an average spatial direction component value comprising the mean of the plurality of subframe spatial direction component values, and the quantised spatial direction component value may be a quantised average spatial direction component value.

A spatial direction component value may be related to a spatial direction parameter, wherein the spatial direction parameter may comprise an azimuth component and an elevation component, and wherein the spatial direction component value may be one of: an x-cartesian component transformed from the azimuth component and elevation component; a y-cartesian component transformed from the azimuth component and elevation component; and a z-cartesian component transformed from the azimuth component and elevation component.

The plurality of audio frames may comprise audio frames prior to the first audio frame of the interval of audio frames.

The plurality of audio frames may comprise the first audio frame of the interval of audio frames and audio frames prior to the first audio frame of the interval of audio frames.

The determination of use of prediction or non-prediction may be signalled as a 1-bit flag.

The interval of audio frames may be a silence descriptor (SID) interval.

There is according to a fourth aspect an apparatus for spatial audio signal decoding configured to: receive a quantised spatial direction component value for a first audio frame of an interval of audio frames; determine whether to use a method of non-prediction for generating at least one spatial direction component value for each remaining frame of the interval of audio frames, wherein all remaining audio frames comprise all but the first audio frame of the interval of audio frames; and determine whether to use a method of prediction for generating at least one spatial direction component value for each remaining frame of the interval of audio frames, wherein all remaining audio frames comprises all but the first audio frame of the interval of audio frames.

The method of non-prediction for generating a spatial direction component value for each remaining frame of the interval of audio frames may comprise the apparatus be configured to: use the received quantised spatial direction component value for the first audio frame of the interval of audio frames as at least one spatial direction component value for each of the remaining frames of the interval of audio frames.

The method of prediction for generating the at least one spatial direction component value for each remaining frame of the interval of audio frames may comprise the apparatus be configured to: determine whether the interval of audio frames is a first interval of audio frames of a silence region of the spatial audio signal or whether the interval of audio frames is a further interval of audio frames of the silence region of the spatial audio signal.

If the interval of audio frames is determined as the first interval of audio frames of the silence region of the spatial audio signal the apparatus may be further configured to: determine coefficients of a backward predictor using a data set comprising a plurality of quantised spatial direction component values drawn from a plurality of audio frames; initialise the backward predictor with the quantised spatial direction component value for the first audio frame of the interval of audio frames; and use the backward predictor to predict the at least one spatial direction component value for each remaining frame of the first interval of audio frames of the silence region.

The backward predictor may be a first order backward predictor, and wherein the coefficients of the backward predictor may be determined using least mean square analysis of the data set comprising the plurality of quantised spatial direction component values drawn from the plurality of audio frames.

If the interval of audio frames is determined as the further interval of audio frames of the silence region of the spatial audio signal, the apparatus may be further configured to: use linear interpolation to interpolate between the quantised spatial direction component value for the first audio frame of the further interval of audio frames of the silence region and a previous quantised spatial direction component value for a first audio frame from a previous interval of audio frames of the silence region; extrapolate the linear interpolation to extend over remaining audio frames of the further interval of audio frames; and assign at least one value from along the extrapolated part of the liner interpolation for each remaining audio frame of the further interval of audio frames, wherein the assigned at least one value is the at least one spatial direction value for the each remaining audio frame of the further interval of audio frames.

The apparatus configured to determine use of the method of prediction or non-prediction may be further configured to: receive a flag signalling the use of prediction or non-prediction; and read the received flag.

A spatial direction component value may be related to a spatial direction parameter, wherein the spatial direction parameter may comprise an azimuth component and an elevation component, and wherein the spatial direction component value may be one of: an x-cartesian component transformed from the azimuth component and elevation component; a y-cartesian component transformed from the azimuth component and elevation component; and a z-cartesian component transformed from the azimuth component and elevation component.

The interval of audio frames may be a silence descriptor (SID) interval.

There is provided according to a second aspect an apparatus for spatial audio encoding comprising

According to a fifth aspect there is an apparatus for spatial audio encoding comprising at least one processor and at least one memory including computer program code, the at least one memory and the computer program code configured to: determine an error of fit measure between a plurality of spatial direction component values from a plurality of audio frames and a curve fitted to a data set comprising the plurality of spatial direction component values; compare the error of fit measure to a threshold value; quantise a spatial direction component value for a first audio frame of an interval of audio frames to give a quantised spatial direction component value for the first audio frame; and depending on the comparison, either use a method of non-prediction for generating at least one spatial direction component value for each remaining audio frame of the interval of audio frames, or use a method of prediction for generating the at least one spatial direction component value for each remaining audio frame of the interval of audio frames, wherein all remaining audio frames comprise all but the first audio frame of the interval of audio frames.

According to a sixth aspect there is an apparatus for spatial audio encoding comprising at least one processor and at least one memory including computer program code, the at least one memory and the computer program code configured to: receive a quantised spatial direction component value for a first audio frame of an interval of audio frames; determine whether to use a method of non-prediction for generating at least one spatial direction component value for each remaining frame of the interval of audio frames, wherein all remaining audio frames comprise all but the first audio frame of the interval of audio frames; and determine whether to use a method of prediction for generating at least one spatial direction component value for each remaining frame of the interval of audio frames, wherein all remaining audio frames comprises all but the first audio frame of the interval of audio frames.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an analysis processor according to some embodiments;

FIG. 3 shows schematically an encoder for operating with a DTX mode according to some embodiments;

FIG. 4 shows schematically a metadata encoder/quantizer when encoding with DTX, according to some embodiments;

FIG. 5 shows a flow diagram of the operation of the metadata encoder/quantizer when operating with DTX according to some embodiments;

FIG. 6 shows a flow diagram of the operation of the spatial metadata encoder 409 when operating with DTX according to some embodiments;

FIG. 7 shows schematically the operation of the spatial metadata encoder 409 when operating in a DTX non-prediction mode according to some embodiments;

FIG. 8 shows schematically the operation of the spatial metadata encoder 409 when operating in a DTX prediction mode according to some embodiments;

FIG. 9 shows schematically the operation of the spatial metadata encoder 409 when operating in a DTX further prediction mode according to some embodiments;

FIG. 10 shows a flow diagram of the operation of the spatial metadata decoder 1109 when operating with DTX according to some embodiments;

FIG. 11 shows schematically shows schematically a metadata extractor according to some embodiments; and

FIG. 12 shows schematically an example device suitable for implementing the apparatus shown.

### EMBODIMENTS

The following describes in further detail suitable apparatus and possible mechanisms for the provision of SID frames for spatial and immersive audio codecs. In the following discussions multi-channel system is discussed with respect to a multi-channel microphone implementation. However as discussed above the input format may be any suitable input format, such as multi-channel loudspeaker, ambisonic (FOA/HOA) etc. It is understood that in some embodiments the channel location is based on a location of the microphone or is a virtual location or direction. Furthermore, the output of the example system is a multi-channel loudspeaker arrangement. However, it is understood that the output may be rendered to the user via means other than loudspeakers. Furthermore, the multi-channel loudspeaker signals may be generalised to be two or more playback audio signals. Such a system is currently being standardised by the 3GPP standardization body as the Immersive Voice and Audio Service (IVAS). IVAS is intended to be an extension to the existing 3GPP Enhanced Voice Service (EVS) codec in order to facilitate immersive voice and audio services over existing and future mobile (cellular) and fixed line networks. An application of IVAS may be the provision of immersive voice and audio services over 3GPP fourth generation (4G) and fifth generation (5G) networks. In addition, the IVAS codec as an extension to EVS may be used in store and forward applications in which the audio and speech content is encoded and stored in a file for playback. It is to be appreciated that IVAS may be used in conjunction with other audio and speech coding technologies which have the functionality of coding the samples of audio and speech signals.

Metadata-assisted spatial audio (MASA) is one input format proposed for IVAS. MASA input format may comprise a number of audio signals (1 or 2 for example) together with corresponding spatial metadata. The encoder may utilize, e.g., a combination of mono and stereo encoding tools and metadata encoding tools for efficient transmission of the format. MASA is a parametric spatial audio format suitable for spatial audio processing. Parametric spatial audio processing is a field of audio signal processing where the spatial aspect of the sound (or sound scene) is described using a set of parameters. The MASA input stream may be captured using spatial audio capture with a microphone array which may be mounted in a mobile device for example. It is a typical and an effective choice to estimate from the microphone array signals a set of parameters such as directions of the sound in frequency bands, and the relative energies of the directional and non-directional parts of the captured sound in frequency bands, expressed for example as a direct-to-total ratio or an ambient-to-total energy ratio in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The MASA spatial metadata may consist of a Direction index, describing a direction of arrival of the sound at a time-frequency parameter interval; level/phase differences; Direct-to-total energy ratio, describing an energy ratio for the direction index; Diffuseness; Coherences such as Spread coherence describing a spread of energy for the direction index; Diffuse-to-total energy ratio, describing an energy ratio of non-directional sound over surrounding directions; Surround coherence describing a coherence of the non-directional sound over the surrounding directions; Remainder-to-total energy ratio, describing an energy ratio of the remainder (such as microphone noise) sound energy to fulfil requirement that sum of energy ratios is 1; Distance, describing a distance of the sound originating from the direction index in meters on a logarithmic scale; covariance matrices related to a multi-channel loudspeaker signal, or any data related to these covariance matrices. Additionally, other parameters for guiding or controlling a specific decoder e.g., VAD/DTX/CNG/SID parameters may also be derived by a spatial audio coding system such IVAS. Any of these parameters can be determined in frequency bands.

The types of spatial audio parameters which make up the spatial metadata for MASA are shown in Table 1 below for each considered time-frequency (TF) block or tile, in other words a time/frequency sub band. The direction parameters are spherical directions comprising an azimuth component and a spherical component. Some embodiments may deploy more than one direction parameter per TF tile.

| Field | Bits | Description |
|---|---|---|
| Direction | 16 | Direction of arrival of the sound at a time- |
| index | | frequency parameter interval. Spherical |
| | | representation at about 1-degree accuracy. |
| | | Range of values: “covers all directions |
| | | at about 1° accuracy” |
| Direct-to- | 8 | Energy ratio for the direction index |
| total energy | | (i.e., time-frequency subframe). |
| ratio | | Calculated as energy in direction/total energy. |
| | | Range of values: [0.0, 1.0] |
| Spread | 8 | Spread of energy for the direction index |
| coherence | | (i.e., time-frequency subframe). |
| | | Defines the direction to be reproduced |
| | | as a point source or coherently around |
| | | the direction. |
| | | Range of values: [0.0, 1.0] |
| Diffuse-to- | 8 | Energy ratio of non-directional sound |
| total energy | | over surrounding directions. |
| ratio | | Calculated as energy of non-directional |
| | | sound/total energy. |
| | | Range of values: [0.0, 1.0] |
| | | (Parameter is independent of number |
| | | of directions provided.) |
| Surround | 8 | Coherence of the non-directional sound |
| coherence | | over the surrounding directions. |
| | | Range of values: [0.0, 1.0] |
| | | (Parameter is independent of number |
| | | of directions provided.) |
| Remainder-to- | 8 | Energy ratio of the remainder (such as |
| total energy | | microphone noise) sound energy to fulfil |
| ratio | | requirement that sum of energy ratios is 1. |
| | | Calculated as energy of remainder |
| | | sound/total energy. |
| | | Range of values: [0.0, 1.0] |
| | | (Parameter is independent of number |
| | | of directions provided.) |
| Distance | 8 | Distance of the sound originating from |
| | | the direction index (i.e., time-frequency |
| | | subframes) in meters on a logarithmic scale. |
| | | Range of values: for example, 0 to 100 m. |
| | | (Feature intended mainly for future |
| | | extensions, e.g., 6DoF audio.) |

This data may be encoded and transmitted (or stored) by the encoder in order to be able to reconstruct the spatial signal at the decoder.

As discussed above Voice Activity Detection (VAD) may be employed in such a codec to control Discontinuous Transmission (DTX), Comfort Noise Generation (CNG) and Silence Descriptor (SID) frames.

Furthermore, as discussed above CNG is a technique for creating a synthetic background noise to fill silence periods that would otherwise be observed, e.g., under the DTX operation. However, a complete silence can be confusing or annoying to a receiving user. For example, the listener could judge that the transmission may have been lost and then unnecessarily say “hello, are you still there?” to confirm or simply hang up. On the other hand, sudden changes in sound level (from total silence to active background and speech or vice versa) could also be very annoying. Thus, CNG is applied to prevent a sudden silence or sudden change. Typically, the CNG audio signal output is based on a highly simplified transmission of noise parameters.

There are currently no proposed spatial audio DTX, CNG and SID implementations. One relatively straightforward solution to the problem of implementing SID in a spatial audio environment would be to simply encode the parameters of the parametric representation such as the spatial directions and energy ratios for each frequency sub band, which could then be transmitted every 8^{th} or so frame similarly to existing DTX systems. However, there are problems with this approach. For instance, if there is a dynamic aspect to the sound scene, such as the user rotating the capture device, the background noise sound scene may be perceived by the end user as being updated in a staccato or jumpy manner, due to the SID update interval being of the order of several audio frames. Therefore, the rate of change in the spatialization of the background noise may be perceived by the listener as being annoying or confusing. For instance, if a SID interval of 160 ms is used (i.e., SID updates are transmitted every 8th 20 ms audio frame) then this may result in an update rate which is too long to provide a smooth transition in background noise direction as perceived by the user. Furthermore, a long SID update interval, as in use by most coding systems, would also result in a noticeable lag for any change in direction of the source. The concept as discussed hereafter is to provide embodiments which compensate for the above effects of having a SID update interval of the order of multiple audio frame lengths when the direction of the background noise is changing at a rate which is higher than the SID update rate.

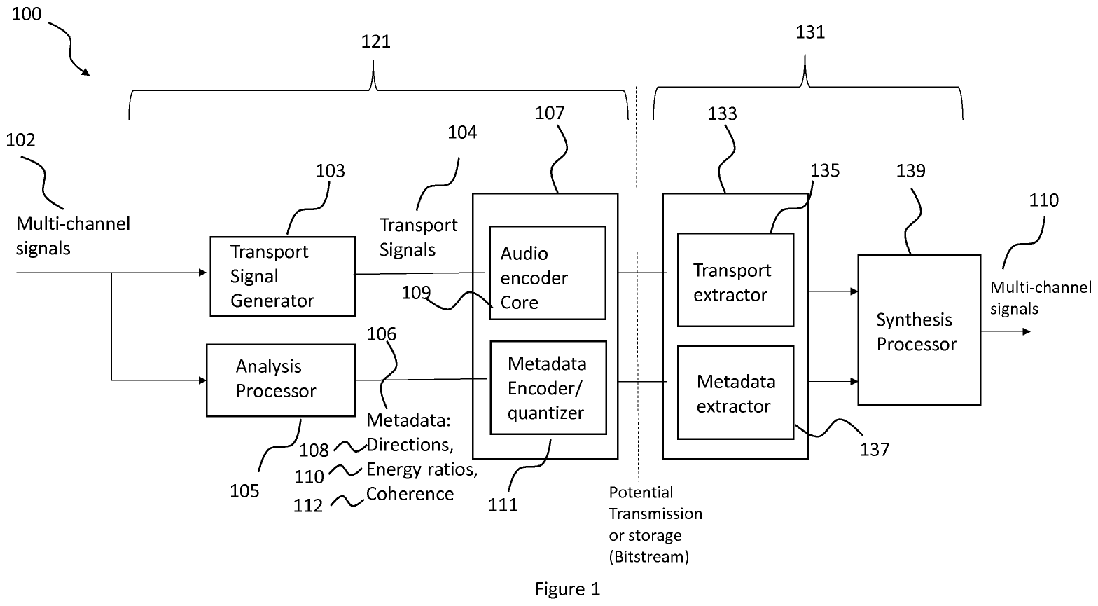

In this regard FIG. 1 depicts an example apparatus and system for implementing embodiments of the application. The system 100 is shown with an ‘analysis’ part 121 and a ‘synthesis’ part 131. The ‘analysis’ part 121 is the part from receiving the multi-channel loudspeaker signals up to an encoding of the metadata and downmix signal and the ‘synthesis’ part 131 is the part from a decoding of the encoded metadata and downmix signal to the presentation of the re-generated signal (for example in multi-channel loudspeaker form).

The input to the system 100 and the ‘analysis’ part 121 is the multi-channel signals 102. In the following examples a microphone channel signal input is described, however any suitable input (or synthetic multi-channel) format may be implemented in other embodiments. For example, in some embodiments the spatial analyser and the spatial analysis may be implemented external to the encoder. For example, in some embodiments the spatial metadata associated with the audio signals may be provided to an encoder as a separate bit-stream. In some embodiments the spatial metadata may be provided as a set of spatial (direction) index values. These are examples of a metadata-based audio input format.

The multi-channel signals are passed to a transport signal generator 103 and to an analysis processor 105.

In some embodiments the transport signal generator 103 is configured to receive the multi-channel signals and generate a suitable transport signal comprising a determined number of channels and output the transport signals 104. For example, the transport signal generator 103 may be configured to generate a 2-audio channel downmix of the multi-channel signals. The determined number of channels may be any suitable number of channels. The transport signal generator in some embodiments is configured to otherwise select or combine, for example, by beamforming techniques the input audio signals to the determined number of channels and output these as transport signals.

In some embodiments the transport signal generator 103 is optional and the multi-channel signals are passed unprocessed to an encoder 107 in the same manner as the transport signal are in this example.

In some embodiments the analysis processor 105 is also configured to receive the multi-channel signals and analyse the signals to produce metadata 106 associated with the multi-channel signals and thus associated with the transport signals 104. The analysis processor 105 may be configured to generate the metadata which may comprise, for each time-frequency analysis interval, a direction parameter 108 and an energy ratio parameter 110 and a coherence parameter 112 (and in some embodiments a diffuseness parameter). The direction, energy ratio and coherence parameters may in some embodiments be considered to be spatial audio parameters. In other words, the spatial audio parameters comprise parameters which aim to characterize the sound-field created/captured by the multi-channel signals (or two or more audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport signals 104 and the metadata 106 may be passed to an encoder 107.

The encoder 107 may comprise an audio encoder core 109 which is configured to receive the transport (for example downmix) signals 104 and generate a suitable encoding of these audio signals. The encoder 107 can in some embodiments be a computer (running suitable software stored on memory and on at least one processor), or alternatively a specific device utilizing, for example, FPGAs or ASICs. The encoding may be implemented using any suitable scheme. The encoder 107 may furthermore comprise a metadata encoder/quantizer 111 which is configured to receive the metadata and output an encoded or compressed form of the information. In some embodiments the encoder 107 may further interleave, multiplex to a single data stream or embed the metadata within encoded downmix signals before transmission or storage shown in FIG. 1 by the dashed line. The multiplexing may be implemented using any suitable scheme.

In the decoder side, the received or retrieved data (stream) may be received by a decoder/demultiplexer 133. The decoder/demultiplexer 133 may demultiplex the encoded streams and pass the audio encoded stream to a transport extractor 135 which is configured to decode the audio signals to obtain the transport signals. Similarly, the decoder/demultiplexer 133 may comprise a metadata extractor 137 which is configured to receive the encoded metadata and generate metadata. The decoder/demultiplexer 133 can in some embodiments be a computer (running suitable software stored on memory and on at least one processor), or alternatively a specific device utilizing, for example, FPGAs or ASICs.

The decoded metadata and transport audio signals may be passed to a synthesis processor 139.

The system 100 ‘synthesis’ part 131 further shows a synthesis processor 139 configured to receive the transport and the metadata and re-creates in any suitable format a synthesized spatial audio in the form of multi-channel signals 110 (these may be multichannel loudspeaker format or in some embodiments any suitable output format such as binaural or Ambisonics signals, depending on the use case or indeed a MASA format) based on the transport signals and the metadata.

Therefore, in summary first the system (analysis part) is configured to receive multi-channel audio signals.

Then the system (analysis part) is configured to generate a suitable transport audio signal (for example by selecting or downmixing some of the audio signal channels) and the spatial audio parameters as metadata.

The system is then configured to encode for storage/transmission the transport signal and the metadata.

After this the system may store/transmit the encoded transport and metadata.

The system may retrieve/receive the encoded transport and metadata.

Then the system is configured to extract the transport and metadata from encoded transport and metadata parameters, for example demultiplex and decode the encoded transport and metadata parameters.

The system (synthesis part) is configured to synthesize an output multi-channel audio signal based on extracted transport audio signals and metadata.

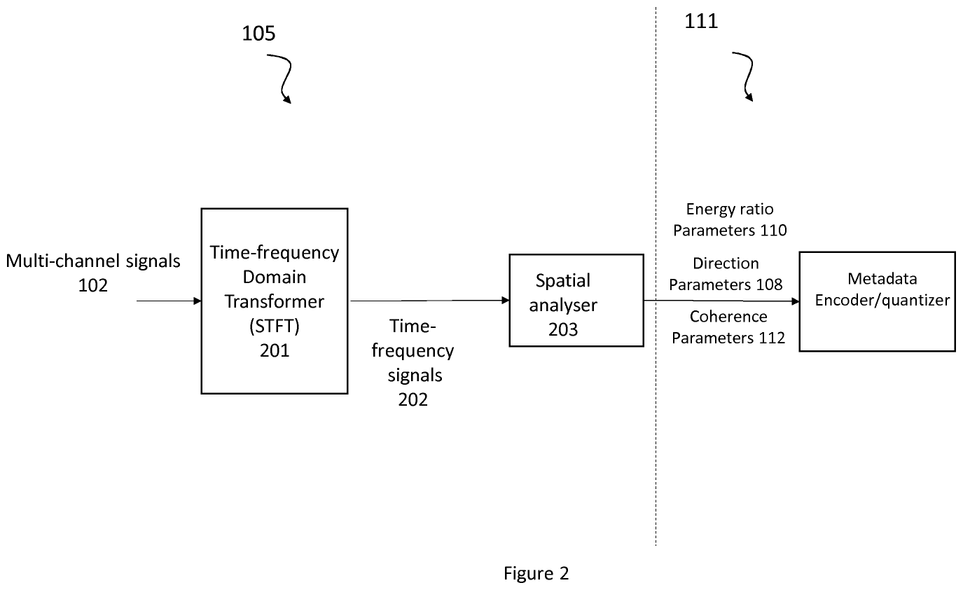

With respect to FIG. 2 an example analysis processor 105 and Metadata encoder/quantizer 111 (as shown in FIG. 1) according to some embodiments is described in further detail.

FIGS. 1 and 2 depict the Metadata encoder/quantizer 111 and the analysis processor 105 as being coupled together. However, it is to be appreciated that some embodiments may not so tightly couple these two respective processing entities such that the analysis processor 105 can exist on a different device from the Metadata encoder/quantizer 111. Consequently, a device comprising the Metadata encoder/quantizer 111 may be presented with the transport signals and metadata streams for processing and encoding independently from the process of capturing and analysing.

The analysis processor 105 in some embodiments comprises a time-frequency domain transformer 201.

In some embodiments the time-frequency domain transformer 201 is configured to receive the multi-channel signals 102 and apply a suitable time to frequency domain transform such as a Short Time Fourier Transform (STFT) in order to convert the input time domain signals into a suitable time-frequency signals. These time-frequency signals may be passed to a spatial analyser 203.

Thus for example, the time-frequency signals 202 may be represented in the time-frequency domain representation by

sᵢ(b,n),

where b is the frequency bin index and n is the time-frequency block (sub frame) index and i is the channel index. In another expression, n can be considered as a time index with a lower sampling rate than that of the original time-domain signals. These frequency bins can be grouped into sub bands that group one or more of the bins into a sub band of a band index k=0, . . . , K−1. Each sub band k has a lowest bin b_{k,low} and a highest bin b_{k,high}, and the subband contains all bins from b_{k,low} to b_{k,high}. The widths of the sub bands can approximate any suitable distribution. For example, the Equivalent rectangular bandwidth (ERB) scale or the Bark scale.

A time frequency (TF) tile (or block) is thus a specific sub band within a subframe of the frame.

In embodiments the analysis processor 105 may comprise a spatial analyser 203. The spatial analyser 203 may be configured to receive the time-frequency signals 202 and based on these signals estimate direction parameters 108. The direction parameters may be determined based on any audio based ‘direction’ determination.

For example, in some embodiments the spatial analyser 203 is configured to estimate the direction of a sound source with two or more signal inputs.

The spatial analyser 203 may thus be configured to provide at least one azimuth and elevation for each frequency band and temporal time-frequency block within a frame of an audio signal, denoted as azimuth ϕ(k, n), and elevation θ(k, n). The direction parameters 108 for the time sub frame may be also be passed to the metadata encoder/quantizer 111.

The spatial analyser 203 may also be configured to determine an energy ratio parameter 110. The energy ratio may be considered to be a determination of the energy of the audio signal which can be considered to arrive from a direction. The direct-to-total energy ratio r(k,n) can be estimated, e.g., using a stability measure of the directional estimate, or using any correlation measure, or any other suitable method to obtain a ratio parameter. Each direct-to-total energy ratio corresponds to a specific spatial direction and describes how much of the energy comes from the specific spatial direction compared to the total energy. This value may also be represented for each time-frequency tile separately. The spatial direction parameters and direct-to-total energy ratio describe how much of the total energy for each time-frequency tile is coming from the specific direction. In general, a spatial direction parameter can also be thought of as the direction of arrival (DOA).

In embodiments the direct-to-total energy ratio parameter can be estimated based on the normalized cross-correlation parameter cor′(k, n) between a microphone pair at band k, the value of the cross-correlation parameter lies between −1 and 1. The direct-to-total energy ratio parameter r(k, n) can be determined by comparing the normalized cross-correlation parameter to a diffuse field normalized cross correlation parameter cor_{D}′(k, n) as

$$r ( k , n ) = \frac{c o {r}^{′} ( k , n ) - {cor}_{D}^{′} ( k , n )}{1 - c o {r}_{D}^{′} ( k , n )} .$$

The direct-to-total energy ratio is explained further in PCT publication WO2017/005978 which is incorporated herein by reference.

In embodiments the parameters relating to a second direction (for the TF tile) may be analysed using higher-order directional audio coding with HOA input or the method as presented in the PCT publication WO2019/215391 with mobile device input. Details of Higher-order directional audio coding may be found in the IEEE Journal of Selected Topics in Signal Processing “Sector-Based Parametric Sound Field Reproduction in the Spherical Harmonic Domain,” Volume 9 Issue 5.

The spatial analyser 203 may furthermore be configured to determine a number of coherence parameters 112 which may include surround coherence (γ(k,n)) and spread coherence (ζ(k, n)), both analysed in time-frequency domain.

The spatial analyser 203 may be configured to output the determined coherence parameters spread coherence parameter ζ and surround coherence parameter γ to the spatial parameter set encoder 207.

Therefore, for each TF tile there will be a collection of spatial audio parameters associated with each sound source direction. In this instance each TF tile may have the following spatial parameters associated with it on a per sound source direction basis; an azimuth and elevation denoted as azimuth ϕ(k, n), and elevation θ(k, n), a spread coherence (ζ(k, n)) and a direct-to-total energy ratio parameter r(k, n). In addition, each TF tile may also have a surround coherence (γ(k, n)) which is not allocated on a per sound source direction basis.

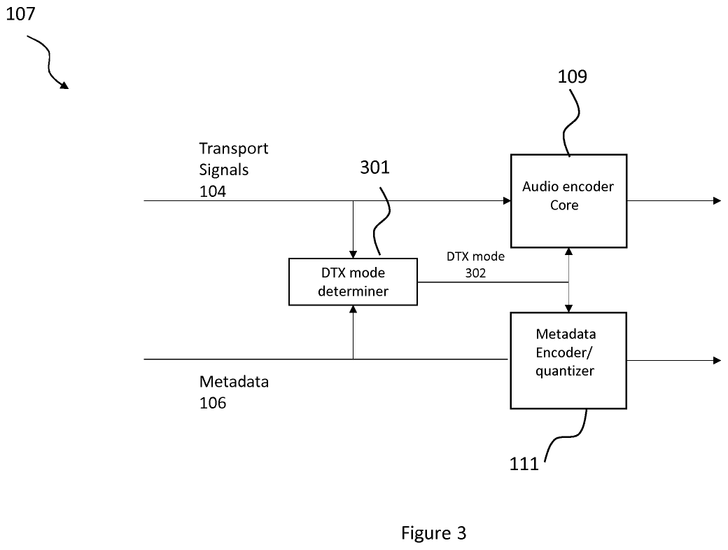

Turning to FIG. 3, the encoder 107 is shown in further detail by depicting a DTX mode determiner 301. The DTX determiner 301 may be arranged to use the transport audio signals 104 and metadata 106 in order to provide the DTX mode signal 302. As depicted in FIG. 3, the DTX mode determiner signal 301 may be fed to the audio encoding core 109 and metadata encoder/quantizer 111. Thereby informing the respective functional blocks to operate in either a DTX mode (DTX mode=on) or in the normal mode of operation (DTX mode=off).

It is to be understood throughout this description that in the context of DTX operation, when DTX mode is off the encoding operation has determined using a signal activity detector that there is no silence region in the current section of the audio signal, and when DTX mode is on the encoding operation has determined that the current section of the audio signal is a silence region. In other words the DTX operation is toggled on and off in response to a signal activity detector such as a VAD.

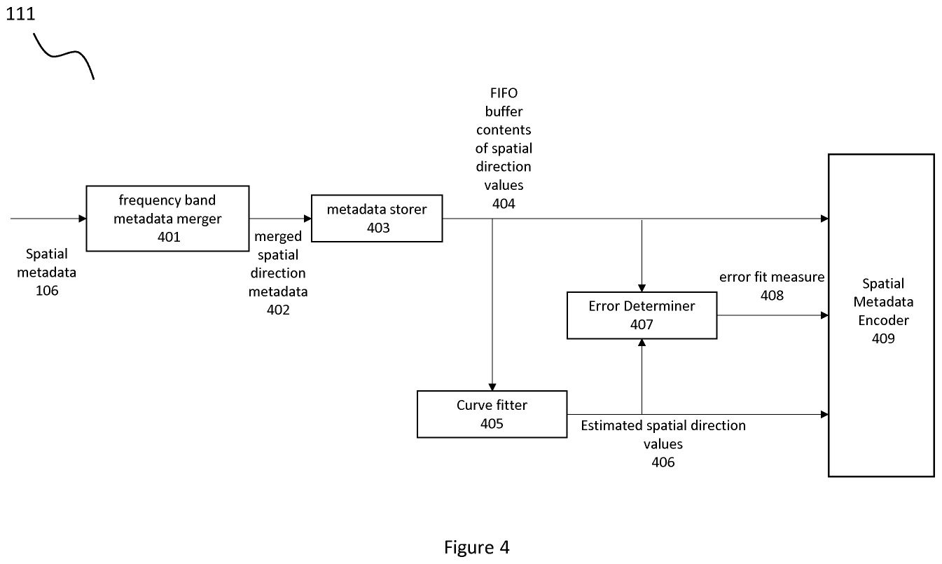

FIG. 4 is a block diagram depicting the functional processing blocks or routines performed when the metadata encoder/quantizer 111 is operating in a DTX mode, in other words when the DTX mode signal 302 holds the state of DTX mode=on.

From FIG. 4, the metadata encoder/quantizer 111 may be arranged to receive the (spatial) metadata 106 via a frequency band metadata merger 401. The frequency band merger may be arranged to merge the spatial metadata into a fewer number of frequency bands. It may be recalled previously that each audio frame is divided into a number of TF tiles. The frequency axis of each audio frame may be divided into a number of frequency bands, where each band has a set of spatial metadata parameters associated with it. For instance, one implementation of the of the IVAS codec may deploy up to 24 bands along the frequency axis. The objective of the frequency band merger 401 is to merge the metadata parameters associated with each frequency band into new set of metadata parameters comprising metadata parameters associated with fewer frequency bands. This may be accomplished by the frequency band metadata merger 401 by merging metadata parameters sets of neighbouring frequency bands into a single merged metadata parameter set. By using this technique, the input metadata parameter sets may be merged into a fewer number of merged metadata parameters sets. For instance, in embodiments an input of 24 metadata parameter sets (that is one metadata parameter set per frequency band) may be merged into five or so merged metadata parameter sets (across the frequency axis). Details of the merging process may be found in the patent application PCT/FI2020/050750. In embodiments the merging process may be performed on a time sub frame basis.

The merging technique as deployed by the frequency band metadata merger 401 may prove useful for reducing the spatial metadata 106, when the metadata encoder/quantizer 111 is operating in a DTX ON mode. However, it is to be understood that the frequency band metadata merger 401 block may be optional in some embodiments, and consequently the above merging step may not be present in these embodiments.

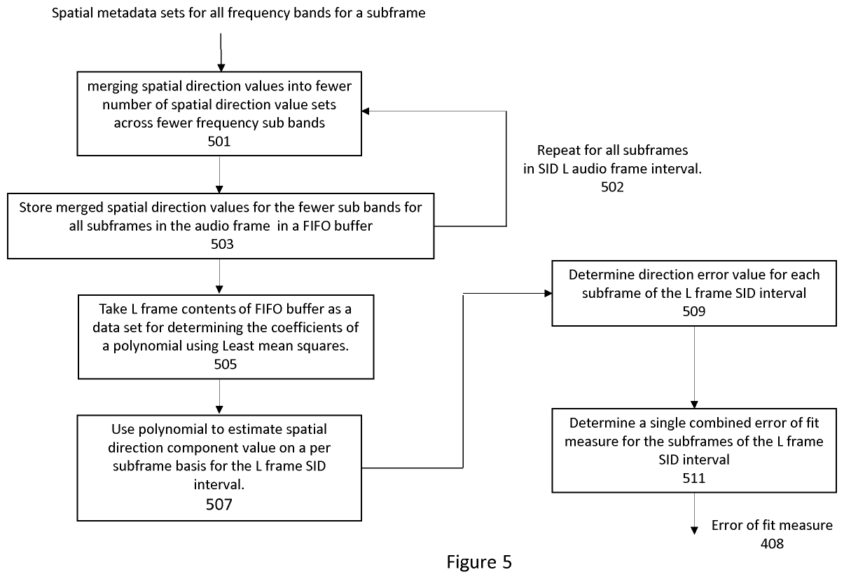

The step of merging spatial metadata sets associated with the frequency bands of the audio signal into fewer number of spatial metadata sets across fewer number of frequency bands for a subframe is shown as the processing step 501 in FIG. 5.

Returning to FIG. 4, the merged metadata parameters 402 may be passed to a metadata storer 403. The metadata storer 403 may be arranged to simply store the last L frames worth of merged metadata parameters. For example, if we have 4 subframes per audio frame, then the metadata storer 403 would be configured to store the last 4×L subframes worth of merged metadata parameter sets. In embodiments the metadata storer 403 may be arranged as first in first out (FIFO) buffer.

In embodiments the value of L may be configured to be the SID interval in terms of number of audio frames. For instance, if a SID update rate of 8 frames is used for IVAS, then L would be set to 8. Obviously other embodiments may deploy other values of L in accordance with their respective SID update intervals/requirements.

FIG. 5 depicts the storing of the merged metadata sets in the FIFO buffer (of the metadata storer 403) on a per subframe basis as the processing step 503. The feedback loop 502 indicates that the merging step 501 and storing step 503 are repeated for all subframes in an audio frame, and for a total of L audio frames (that is the length of the SID interval)

The processing steps performed after 503 may be performed on a per L audio frame basis, i.e. at a SID interval rate.

The contents of the metadata storer's FIFO buffer 404 may be presented to the curve fitter 405 for processing. The curve fitter 405 may be arranged to fit a curve to the metadata spanning the L frames stored in the FIFO buffer. In other words, the curve fitter 405 may be arranged to create a data set by taking the last L×(number of subframes) worth of merged metadata sets and fit the data set to an n-order polynomial. The data set from which the n-order polynomial is fitted runs from the current audio frame and includes the previous L−1 audio frames.

In some embodiments the curve fitting step maybe applied to the spatial direction values in the metadata sets. In this case the curve fitter 405 may be arranged to create a data set by taking the last L*(number of subframes per frame) (that is the current audio frame and the L−1 previous audio frames) worth of merged spatial direction values and fit the data to an n-order polynomial. It is worth noting in these embodiments the spatial direction values for each frequency band may have been merged into neighbouring spatial direction values from neighbouring frequency bands, thereby providing merged spatial direction values across fewer merged frequency bands. To be clear each merged spatial direction value may be associated with a group of neighbouring frequency bands a so-called merged frequency band. Again details, of how spatial direction values can be merged may be found in the patent application in the patent application PCT/FI2020/050750.

Other embodiments may not deploy the merging step 501, and for these embodiments the curve fitter will simply use the original (unmerged) spatial direction parameters for each frequency band.

In embodiments the curve fitting steps are performed on a per frequency band basis irrespective of whether the frequency bands are merged. This means that there is n-order polynomial fitted to the training set on a per frequency band k basis. In essence producing a n-order polynomial for each frequency band k.

As stated previously each spatial direction value (for a frequency band k) may comprise an azimuth direction ϕ(k, n) component and an elevation direction θ(k, n) component, where k is the frequency band, and n denotes a time subframe. The curve fitter 405 may then initially convert the spatial direction value for each frequency band and for each sub frame contained in the FIFO buffer to cartesian coordinates. That is all spatial direction values associated with the L frames contained in the FIFO buffer may be converted into cartesian coordinates using the following.

The X axis direction component as

$$x ( k , n ) = cos ϕ ( k , n ) cos θ ( k , n ) \qquad ( 1 )$$

the Y axis component as

$$y ( k , n ) = sin ϕ ( k , n ) cos θ ( k , n ) \qquad ( 2 )$$

and the Z axis component as

$$z ( k , n ) = sin θ ( k , n ) \qquad ( 3 )$$

The above operation may be performed for all frequency bands k=0 to K−1, and all sub frames n over the L audio frames of the FIFO buffer.

The curve fitter 405 may then be arranged to fit each spatial direction value to an nth-order polynomial to obtain an estimate of the spatial direction value in a least squares sense. For instance, in the case of the spatial direction value comprising an azimuth component and an elevation component the estimate of each spatial direction value may be found by obtaining an estimate of each cartesian component of the direction parameter separately in turn, xₘₛₑ(k, n), yₘₛₑ(k, n), zₘₛₑ(k, n). The spatial direction parameter value estimate may be performed for each sub frame within the L frame SID update interval. As stated earlier this is performed for each frequency band in turn.

In the case of using a first order polynomial (i.e. a straight line) to fit the direction parameter, the estimate of a spatial direction component value for the sub frame n may be given as

xₘₛₑ(k, n)=a₁·xₘₛₑ(k, n−1)+a₀ for all subframes over the range of frames (m−L) to m, where the spatial direction component value in this case is the cartesian x-coordinate.

Where (m−L) to m is the range of audio frame indexes over which the subframe indexes n are taken, and m is the current audio frame. The LN subframes of a SID update interval may be stored in the FIFO buffer, where N is the number of subframes per frame typically this may have a value of 4, xₘₛₑ(k, n−1) is the estimated spatial direction component value for the previous sub frame, and a₁ and a₀ are the first order polynomial coefficients obtained by fitting a first order polynomial over the data set comprising all spatial direction component values of the current SID update interval frame (starting at frame m and going back to frame m−L.) In this case the data set used to obtain the polynomial coefficients comprises all spatial direction component values spanning the subframes over the range of frames m−L to m which in this case will be L·N worth of spatial direction component values.

As explained above the coefficients a₁ and a₀ are found by fitting a first order polynomial to the data set. This may be performed by minimising the error using a least squares approach between the spatial direction component value, for instance the x cartesian coordinate, and the straight line formed at the sampling instance of the spatial direction component value. This maybe expressed as

$$min ε = {\sum }_{i = 1}^{\#\# data points} {( {x}_{i} - ( {a}_{1} \cdot i + {a}_{o} ) )}^{2}$$

Where i is the sampling instance, in this case it is the spatial direction component value index in time for the ith sub frame in the L audio frame time interval. Therefore, if there are N subframes per audio frame, then the size of the data set will be LN data points, one set of spatial direction values per subframe. Then a₁ and a₀ may be found by taking the partial derivatives with respect to a₁ and a₀, and setting the results to zero in order to solve two simultaneous equations

$$\frac{\partial e r r}{\partial {a}_{1}} = - 2 {\sum }_{i = 1}^{L \cdot N} i ( {x}_{i} - {a}_{1} \cdot i - {a}_{o} ) = 0$$

$$\frac{\partial e r r}{\partial {a}_{0}} = - 2 {\sum }_{i = 1}^{L \cdot N} ( {x}_{i} - {a}_{1} \cdot i - {a}_{o} ) = 0$$

The same procedure may be repeated for each of the other spatial direction component values in order to find the estimated value for each L frame interval yₘₛₑ(k, n), zₘₛₑ(k, n), over the range of subframes (m−L) to m.

It is to be appreciated that the above procedure is performed on a per frequency band basis k. So, for each subframe n there will be K spatial direction component values of xₘₛₑ(k, n), yₘₛₑ(k, n), zₘₛₑ(k, n), where the K is the number of frequency bands spanned by the variable k.

The step of using the data set of spatial direction component values over a L frame SID interval to provide the coefficients of the curve fitting polynomial using least squares us shown as processing step 505 in FIG. 5.

The step of determining the estimate of the spatial direction component values for each sub frame within the SID update interval using curve fitting is shown as the processing step 507 in FIG. 5.

The output from the curve fitter 405, the estimated spatial direction component values for each subframe 406 of the L frame SID update interval, may then be passed to the error determiner 407. The error determiner 407 may also receive the original data sets over which the estimates of the spatial direction component values were obtained. In other words, the error determiner 407 may also receive the spatial direction component values for all the subframes 404 spanning the audio frames from m−L to m, i.e., the last LN subframes, including the subframes from the current audio frame.

The error determiner 407 may then be arranged to determine an error direction value between each estimated spatial direction component value and the corresponding original spatial direction component value on a per subframe basis for all subframes in the L frame SID update interval. This may be performed for all the spatial direction component values. For instance, the x cartesian coordinate spatial direction component value may have a subframe error direction component of (xₑₛₜ(k, n)−x(k, n)). Similarly the y cartesian and z cartesian subframe error direction components may be given as (yₑₛₜ(k,n)−y(k,n)) and (zₑₛₜ(k,n)−z(k,n)) respectively.

A direction error value for each subframe may then be obtained by combining the subframe error direction component for each direction component. In embodiments the direction error value for a subframe n maybe given as

$${e}_{e s t} ( k , n ) = \sqrt{{( {x}_{e s t} ( k , n ) - x ( k , n ) )}^{2} + {( {y}_{e s t} ( k , n ) - y ( k , n ) )}^{2} + {( {z}_{e s t} ( k , n ) - z ( k , n ) )}^{2}} .$$

This may be performed for all subframes for the range of frames n=(m−L) to m (covering the subframes from the last L frames including the subframes from the most recent audio frame.)

The direction error value for each subframe may be calculated for each frequency band k.

The step of determining the direction error value for each subframe of the L frame SID update interval is shown as processing step 509 in FIG. 5.

The direction error value for each subframe in the L audio frame interval (the SID interval), may then be further combined into a single error value for the SID interval. In embodiments this may be in the form of a root means square error.

$${e}_{est} ( k ) = \sqrt{\frac{1}{NxL} {\sum }_{N m - N L + n}^{N m} {( {e}_{est} ( k , n ) )}^{2}}$$

The single (or combined error) value for the SID interval may be repeated for each frequency band k. This combined error value for the SID interval may be termed the error of fit measure 408 between the estimated spatial direction values and the original spatial direction values for the SID interval m.

The step of determining an error of fit measure 408 value for the L frame SID interval is shown as step 511 in FIG. 5.

The error of fit measure 408 may then be passed along with the original spatial direction values 404 and the estimated spatial direction values 406 to the spatial metadata encoder 409. The function of the spatial metadata encoder 409 is to generate the SID update parameters for the comfort noise generated spatial audio signal at the decoder.

In general, the spatial metadata encoder 409 may be arranged to operate in two modes of operation for each SID interval, a non-prediction mode and a prediction mode. Furthermore the spatial metadata encoder 409 operates at the granularity of the frame, which means that all prediction is performed across the frames of the SID interval rather than the subframes of the SID interval, and any spatial direction values sent to the decoder are average spatial direction values for the first SID frame of a new SID interval. Within the context of the spatial metadata encoder 409 operating in a SID encoding mode the average spatial direction value refers to the average of the spatial direction values across the subframes of the audio frame.

Note there will be an average spatial direction value for each frequency band k.

In the non-prediction operating mode, the spatial metadata encoder 409 may be arranged to determine that the spatial audio SID update parameters for each frame of the L frame SID update interval are based on the average spatial direction values of the first frame of a SID interval (which is known as the SID frame). At the decoder this means that each frame of the comfort noise signal (of the SID interval) is generated using the average spatial direction values from the SID frame.

In the prediction mode of operation, the SID spatial metadata encoder 409 may be configured to use backward prediction for predicting the spatial direction value for audio frames of the SID interval. Typically, this entails using a previous predicted spatial direction value to predict the spatial direction value for a current audio frame of the SID interval.

In embodiments, the mode of operation of the spatial metadata encoder 409 may be determined by comparing the error of fit measure 408 eₑₛₜ(k) against a threshold tₑₛₜ. If the error fit measure 408 returned by the error determiner 407 is deemed small enough then this would indicate that the backward prediction method of generating the spatial direction values for frames of the CNG signal would produce a perceptually better comfort noise signal (at the decoder) than simply using the same average spatial direction value for each frame.

Consequently, if the error of fit measure 408 is below the threshold eₑₛₜ(k)<tₑₛₜ. The spatial metadata encoder 409 may be arranged to select the prediction mode of encoding the spatial direction values for the all but the first frame of the SID interval. Note the first frame of the SID interval will use the actual quantised average spatial direction value which are sent to the decoder as the SID frame parameter set.

However, if the error of fit measure 408 is above (or equal) to the threshold eₑₛₜ(k)≥tₑₛₜ. Then the spatial metadata encoder 409 may be arranged to select the non-prediction mode of encoding the spatial direction values for the frames of the SID update interval. In other words, in this operating scenario the spatial direction values used for the frames of the CNG signal (at the decoder) are the quantised average spatial direction value from the first frame of the SID interval.

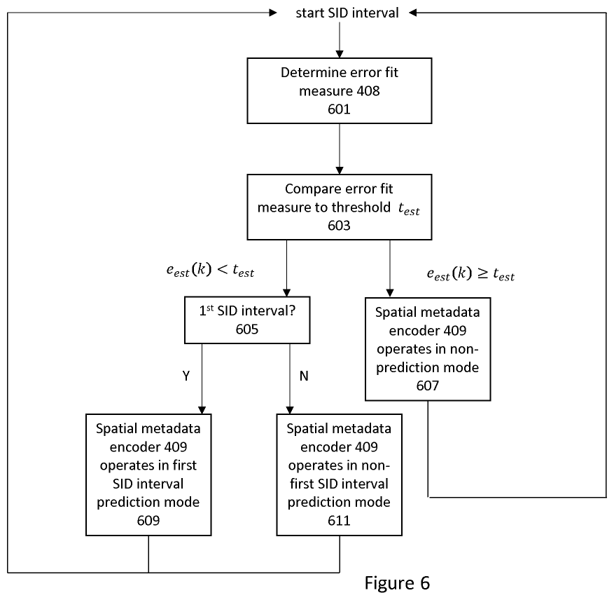

There may be differences in the method of operation of the spatial metadata encoder 409 when the encoder has selected the prediction mode at the start of the SID interval. These differences are a result of whether the mode of operation is determined for the first SID interval of a silence region or whether the mode of operation is determined for a further SID interval (a non-first SID interval) of the silence region. In other words, there may be a specific prediction mode for the first SID interval and a specific prediction mode for a non-first SID interval. In this regard FIG. 6 depicts a flow diagram of the various operating modes of the spatial metadata encoder 409.

From FIG. 6 it can be seen that the decision process for determining the mode of operation of the spatial metadata encoder 409 is initialised by the start of a SID interval, in which the error determiner 407 determines the error fit measure 408 according to the processing steps shown by FIG. 5. This is shown as the processing step 601 in FIG. 6. As explained above the error fit measure 408 is compared against the threshold tₑₛₜ in order to determine whether a prediction mode of operation should be executed for the SID interval, or whether a non-prediction mode of operation should be executed. This is shown as the decision step 603. As explained above if the error of fit measure 408 is above (or equal) to the threshold eₑₛₜ(k)≥tₑₛₜ. Then the spatial metadata encoder 409 may be arranged to select the non-prediction mode of encoding the spatial direction parameters. This is shown as the processing step 607 in FIG. 6. However, if the error of fit measure 408 is below the threshold eₑₛₜ(k)<tₑₛₜ the spatial metadata encoder 409 may be arranged to select the (backward) prediction mode of encoding the spatial direction values for use in the frames of the SID interval. At this point the decision process as executed by the spatial metadata encoder 409 may involve determining whether the SID interval is the first SID interval. That is the first SID interval when there is a DTX ON state indicating the start of a new silence region. If it is determined that the start of the SID interval is the first SID interval of a silence region then the spatial metadata encoder 409 executes the first SID interval method of prediction, in other words the first SID interval prediction mode. This is shown as the processing step 609 in FIG. 6. However, if it is determined at step 605 that the start of the SID interval is not the first SID interval but rather a further SID interval for the silence region. Then the spatial metadata encoder 409 executes non-first SID interval method of backward prediction. This is shown as processing step 611 in FIG. 6. On completion of one of the processing steps 607, 609 and 611 the process loops back to await the start of the next SID interval. At this point the error determiner 407 will then determine the error fit measure 408 for the next SID interval according to the processing steps shown by FIG. 5, and the processing steps of FIG. 6 may be repeated. This may continue until the end of the silence region is indicated by the DTX changing to an OFF state.

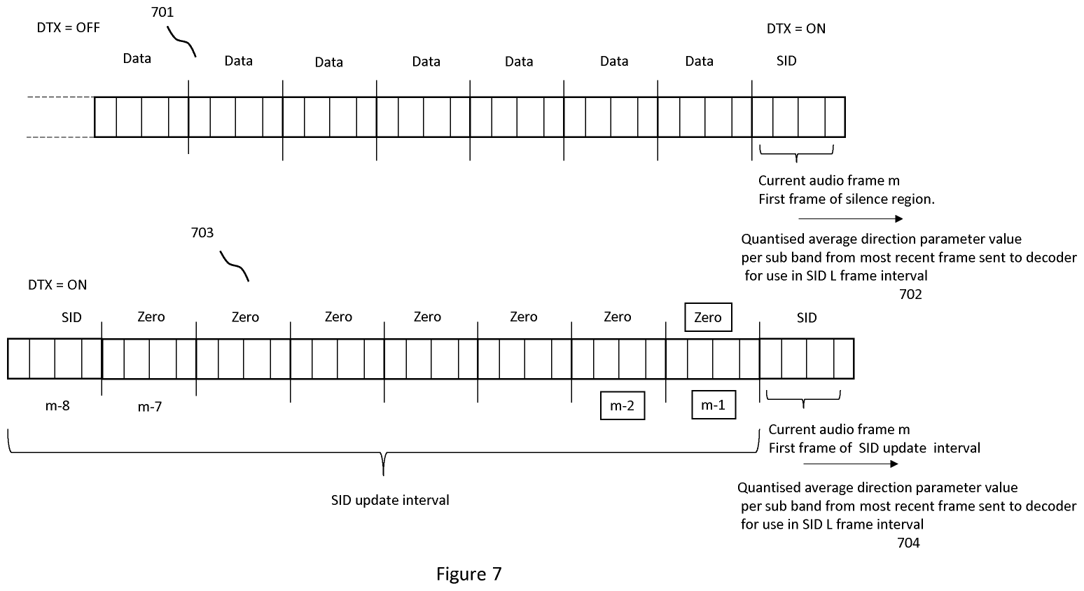

With reference to FIG. 7 there is shown an illustration of the operation of the spatial metadata encoder 409 operating in the non-predictive mode. In this regard 701 depicts the scenario of the first SID interval, when the DTX changes from an OFF to an ON state, in other words the start of a new silence region. From 701 the quantised average spatial direction value, which form part of the SID parameters which are sent to the decoder, may be drawn from the first frame of the first SID interval 702, in other words the first audio frame of the silence region. With further reference to FIG. 7, 703 illustrates the operation of the spatial metadata encoder 409 following the scenario of a SID update at the start of a new SID interval following the first SID interval. In this case the of the new SID interval is preceded by L−1 zero data frames, in which no data is sent to the decoder. In this instance the spatial direction values which are sent to the decoder are quantised average spatial direction value for the first frame of the new SID interval. The SID parameter update is shown in 703 as being updated according to the first audio frame 704 after the L frame update interval (in this instance L=8).

It is to be appreciated in embodiments that when the spatial metadata encoder 409 is operating in the non-prediction mode, the spatial direction value sent to the decoder may in some embodiments be the quantised average spherical direction value from the first frame of the SID interval. Whilst operating in this mode, the cartesian based spatial direction component values are used primarily for deriving the error fit measure 408. The quantised average spherical direction value are sent on a per frequency band k basis. However, other embodiments may send quantised average cartesian coordinate values from the first frame of the SID interval instead.

Furthermore, whilst the spatial metadata encoder 409 operates in the non-prediction mode, the quantised average spherical direction values for the SID frame may be stored at the encoder. These parameters may then become past quantised average spherical direction values for use in any future SID intervals for which the spatial metadata encoder 409 uses a prediction mode of operation.

When the spatial metadata encoder 409 is operating in the first SID interval prediction mode of operation, the spatial metadata encoder 409 uses a method of backward prediction to provide a predicted spatial direction value for each zero frame of the L frame SID update interval. This prediction process is performed both at the encoder and decoder such that their respective predictor memories remain synchronised. As an aside, the SID parameter set associated with first frame of the SID interval (the SID frame) comprises the quantised average spatial direction value. These are then directly used to generate the comfort noise signal for the first frame of the SID interval at the decoder and also to initialise the backward predictors such that the comfort noise signal may be generated for the following zero frames of the SID interval.

In this operating scenario the spatial metadata encoder 409 may be arranged to use a backward first order predictor of the form

$${x}_{est} ( k , m ) = {b}_{1} ( k ) {x}_{est} ( k , m - 1 ) + {b}_{0} ( k ) \qquad ( 4 )$$

In essence the spatial direction value for the frame m maybe predicted from the predicted spatial direction value from the previous frame m−1. There are three points to note with the first order predictor. Firstly, the prediction is performed for each of the spatial direction cartesian component values, xₑₛₜ(k, m) yₑₛₜ(k, m) and zₑₛₜ(k, m) in turn, for a zero frame of the SID interval. In effect there will be three separate backward predictors, one for each cartesian domain component. Secondly all prediction is performed at the encoder using quantized spatial direction values. So, in the case of the above cartesian coordinate prediction system, any spatial direction spherical values would have been quantised before being converted to their equivalent cartesian coordinate system. Thirdly, the prediction of the spatial direction value may be performed on a per frequency band, k, basis.

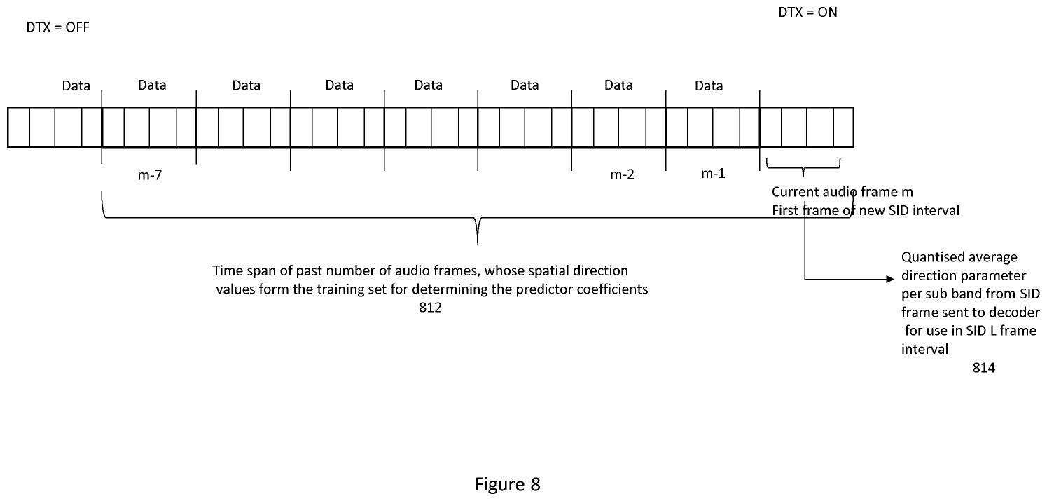

The prediction coefficients b₁(k) and b₀(k) can be found using least mean square analysis of past quantized directions. In particular, the spatial metadata encoder 409 may use a data set comprising the past quantized average spatial direction component values for a number of previous audio frames before the start of the first SID interval. In embodiments, the training set may comprise the L previous audio frames before the start of the first SID update interval. For example, in the case of an SID interval of L=8 audio frames, the spatial metadata encoder 409 may use a data set spanning all frames from the audio frame of the first SID update interval to 7 audio frames prior to the start of the first SID interval. So, let's assume the first SID update interval starts at frame m, then the training set will comprise all quantised average direction component values from the frames spanning m to m−7. In this respect, FIG. 8 is an illustration of the operation of the spatial metadata encoder 409 operating in the first SID interval predictive mode. 810 depicts the past frames whose quantised average spatial direction component values are used as the training set for determining the prediction coefficients b₁(k) and b₀(k). This is shown as 812 in FIG. 8, where the quantised average spatial direction component values over the range of audio frames m to m−7 are used. Other embodiments may use the quantised average spatial direction component values over a different number of past audio frames. Note, quantised spatial direction component values are the respective cartesian direction components.

In a manner similar to the method used to obtain the error fit measure 408, the values of the prediction coefficients b₁(k) and b₀(k) can be found by partial differentiating equation (4) with respect to b₁ and b, and setting the results to zero in order to solve two simultaneous equations.

As explained above the spatial metadata encoder 409 may be arranged to use a backward first order predictor for the spatial direction component value on a frame basis at the encoder which is replicated at the decoder, thereby providing predicted spatial direction component value for each frame of the SID interval at the decoder. To achieve this the backward predictors at the encoder and decoder may both apply the same initial condition. In embodiments this initial condition may comprise the quantised average spatial direction component value which form the SID parameters sent from the encoder to the decoder. This is shown in FIG. 8 as the quantised average spatial direction component value for the SID frame 814, which are depicted as being sent to the decoder.

As a note, the actual spatial direction value sent to the decoder may be the quantised average spherical direction value for the frame in question. At the decoder these quantised spherical values will be converted into the respective quantised average spatial direction cartesian components, which will then be used to initialise the respective backward predictor.

As stated above the backward predictors are used to predict the spatial direction value for the first zero frame, and this will be initialised with the quantised average spatial direction component (cartesian) value from the first frame 814 of the SID interval denoted as \hat{x}(k, 0). In other words, the prediction of the spatial direction values for the zero frames of the SID interval may be based on the quantised average spatial direction component (cartesian) value from the first frame 814 of the SID interval. The predicted spatial direction component value for the first zero frame (the second frame of the SID interval) may be given for the x-cartesian coordinate as

$${x}_{est} ( k , 1 ) = {b}_{1} ( k ) \hat{x} ( k , 0 ) + {b}_{0} ( k ) \qquad ( 5 )$$

Obviously, the spatial direction values for the first frame (the SID frame) of the SID interval are given as the average quantised spatial direction value sent over to the decoder as part of the SID frame parameter set.

The predicted spatial direction component value for the second zero frame (third frame of the SID interval) may be given as

$${x}_{est} ( k , 2 ) = {b}_{1} ( k ) {x}_{est} ( k , 1 ) + {b}_{0} ( k ) \qquad ( 6 )$$

and so on. This backward prediction will be repeated until all zero frames of the SID interval have a predicted spatial direction value. In the embodiment according to FIG. 8, the backward prediction step will be repeated 7 times in total, in accordance with the number of zero frames.

Just to reiterate, this backward prediction step may be performed for each of the cartesian coordinates (spatial direction component value) in turn.

With reference to the above equations (5) and (6). These equations are written in terms of predicting a spatial direction value for each audio frame. However, the person skilled in the art would understand that equations (5) and (6) can be iterated at the subframe level. In other words, the above backward prediction steps according to equations (5) and (6) may arranged to produce a predicted spatial direction value for each subframe with in the SID interval.

Furthermore, in some embodiments the above prediction can be performed using a spherical coordinate as the spatial direction component value. For instance, equations (5) and (6) may be expressed in terms of the azimuth value and the elevation value. For instance, for the azimuth value equations (5) and (6) may take the form of

$${ϕ}_{est} ( k , 1 ) = {b}_{1} ( k ) \hat{ϕ} ( k , 0 ) + {b}_{0} ( k )$$

$$and$$

$${ϕ}_{est} ( k , 2 ) = {b}_{1} ( k ) {ϕ}_{est} ( k , 1 ) + {b}_{0} ( k ) .$$

In these embodiments the prediction coefficients b₁(k) and b₀(k) may be found using a training set comprising past quantized spatial spherical direction values.

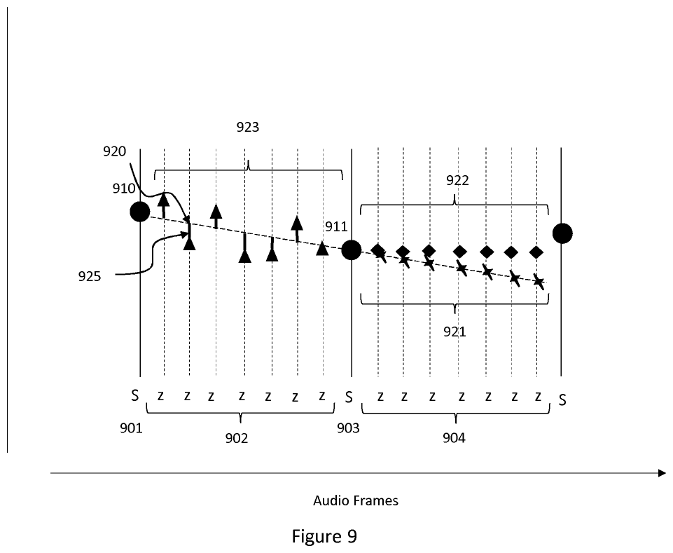

When the spatial metadata encoder 409 is operating in the non-first SID interval prediction mode of operation. In other words, the scenario of sending SID update parameters for a new SID interval after the first SID frame, and therefore after a period in which there has been no data frames (termed zero data frames) sent to the decoder. The spatial metadata encoder 409 uses a method of linear interpolation between two points to provide the prediction of the spatial direction parameters for the upcoming zero frames. In this regard FIG. 9 illustrates how the spatial direction values for the upcoming zero frames are predicted. FIG. 9 shows a SID frame 901 followed by seven zero frames 902, then followed by a further SID frame 903 (start of a new SID interval). Also shown in FIG. 9 are the quantised spatial direction values which may form part of the SID update parameters. These are depicted as 910 for the SID frame 901 and 911 for the SID frame 903. In this instance, the spatial metadata encoder 409 may then use linear interpolation between the two values of quantised spatial direction values 910 and 911 to predict the spatial direction values for the following set of zero frames 904. The linear interpolation is depicted as 920 in FIG. 9, where the straight line 920 has been extrapolated to the following set of zero frames 904. The predicted spatial direction values for the zero frames 904 may then lie along the line 920, which are shown as the star values 921 in FIG. 9. It can be seen that a predicted spatial direction value for a zero frame 904 may be given as the value on the extended linear interpolated line which corresponds in time to the start of the zero frame.

It is to be recalled that at the beginning of each SID interval an error of fit measure process is performed 601 and then tested against a threshold value 603 to determine whether the prediction method is used or the non-prediction method is used for the spatial direction values of the subsequent zero frames (of the SID interval). Therefore, with this in mind returning to FIG. 9, a decision is made at the SID frame 903 as to whether prediction is used or whether the quantised spatial direction values are repeated for each of the zero frames 904. For completeness the non-predicted spatial direction value for the SID frame 903 are shown by the diamond symbols 922, where it can be seen the spatial direction value for each zero frame is simply formed by repeating the quantised spatial direction value 911 for all zero frames 904. To be clear, the spatial direction values for the zero frames 904 will either be the non-predicted values 922 or the predicted values 921, and the choice as to whether the predicted values 921 are calculated may be determined by the earlier processing steps of 601 and 603. The error of fit measure 408 may be determined in a different manner to the method used for the first SID frame of a silence region. In this instance, the error fit measure calculated at the SID frame 903 may be determined by using the actual spatial direction values from the zero frames of the previous SID interval 902 and determining the square of the distance between each actual value of the actual average spatial direction value for a zero frame and the corresponding liner interpolated (predicted) value from the graph 920. This may be repeated for each zero frame of the previous SID interval. This can be seen in FIG. 9, where the “triangle points” represent the actual or original spatial direction values 923 for the zero frames of the past SID interval 902. The difference between each original spatial direction value and the predicted value for a zero frame of a past SID interval 902 is given as a solid line in FIG. 9, of which 925 serves as an example.

Using a similar error methodology as above the estimated error between original spatial direction value and the predicted value for a zero frame of a past SID interval may be given for the cartesian coordinate system as

$${e}_{e s t} ( k , m ) = \sqrt{{( {x}_{e s t} ( k , m ) - x ( k , m ) )}^{2} + {( {y}_{e s t} ( k , m ) - y ( k , m ) )}^{2} + {( {z}_{e s t} ( k , m ) - z ( k , m ) )}^{2}} .$$

Where xₑₛₜ(k, m) is the predicted x-cartesian coordinate as predicted using the line 920 for the past zero frame m, and x(k, m) is the original (or actual) value for the past zero frame m. Similarly, yₑₛₜ(k, m) and zₑₛₜ(k, m) are the predicted y-cartesian and z-cartesian coordinates respectively for the past zero frame m, y(k, m) and z(k, m) are the original values for the past zero frame m.

The error of fit measure 408 for the zero frames of the past SID interval 902, in other words the error of fit measure 408 used in the determining step 601 at the SID frame 911 for the SID interval 904, may be given as

$${e}_{est} ( k ) = \sqrt{\frac{1}{L - 1} {\sum }_{m = m - L - 1}^{m - 1} {( {e}_{est} ( k , m ) )}^{2}}$$

The error of fit measure eₑₛₜ(k) 408 may be given as the root means square estimated error for the zero frames of the past SID interval. This is performed on a per frequency band basis.

In other embodiments the above spatial metadata encoder 409 when operating in the non-first SID interval prediction mode of operation, may use spatial spherical direction values instead of the spatial cartesian direction values as described above. In these embodiments the spatial metadata encoder 409 may use linear interpolation between two values of quantised spatial spherical direction values to predict a spatial spherical direction value for the following set of zero frames. Therefore the output of the spatial metadata encoder 409 when operating in a DTX mode may comprise, for the SID frame of each SID interval, metadata comprising the quantised average spatial direction value in the form of the quantised average spherical direction value in one embodiment or the quantised average cartesian coordinate value in another embodiment and additionally a 1 bit use_prediction flag to indicate whether prediction is used for the zero frames of the SID interval.

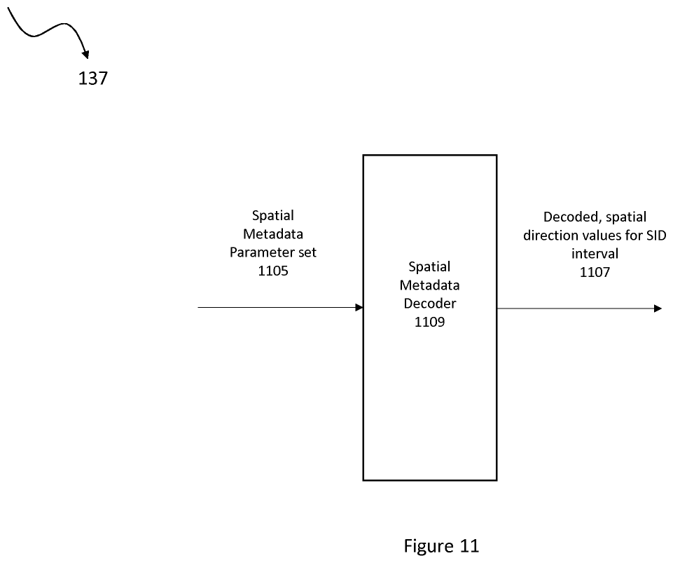

With reference to FIG. 11 there is shown a spatial metadata decoder 1109, which may form part of the metadata extractor 137. FIG. 11 depicts the spatial metadata decoder 1109 as receiving the spatial metadata parameter set 1105. When the decoder is operating in a DTX mode the parameter set may comprise the SID parameters of a SID frame denoting the start of a new SID interval. The SID parameters may comprise at least a quantised average spatial direction value for the SID frame and a use_predictor flag. The output 1107 from the spatial metadata encoder 1109 may comprise at least an average spatial direction value for each frame of the SID interval, that is an average spatial direction value for the SID frame and each zero frame of the SID interval.

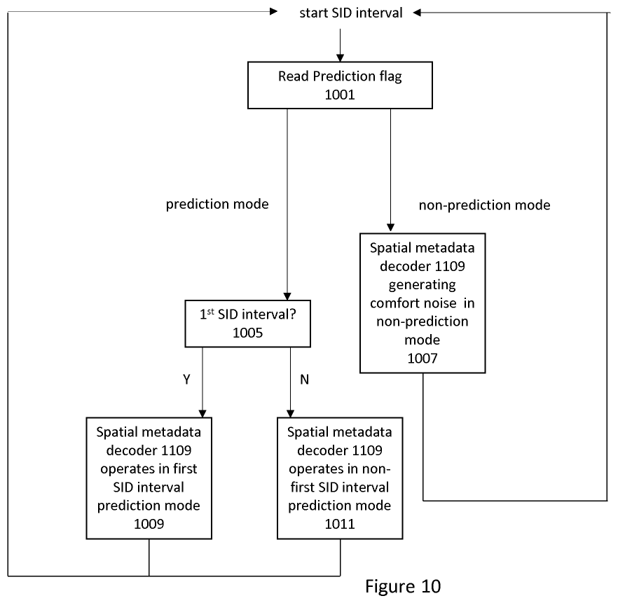

With reference to FIG. 10 there is a flow diagram depicting the operation of a spatial metadata decoder 1109 operating in a comfort noise generation (CNG) mode of operation. That is the metadata extractor 137 has decoded an indication from the bitstream that the metadata contained therein for an audio frame is a SID audio frame. In this case the spatial metadata decoder 1109 of the metadata extractor 137 will be arranged to decode the encoded metadata for the generation of comfort noise. In this regards FIG. 10 depicts the processing of the spatial metadata decoder 1109 from the time of receiving a SID frame, in other words the first frame of a SID interval. Firstly, the spatial metadata decoder 1109 may read the use_prediction flag contained within the metadata which is received as part of the SID parameter set. From the reading of the use_prediction flag, the spatial metadata decoder 1109 can determine whether it is required to operate in either a prediction mode of operation or a non-prediction mode of operation. With respect to FIG. 10 this decision step is shown as step 1001. If it is determined at step 1001 that the spatial metadata decoder 1109 is to operate in a non-prediction mode the spatial metadata decoder 1109 will simply decode the received quantised average spatial direction value (as received in the SID frame) and apply them to each frame of the SID interval for the generation of the comfort noise signal. That is the same quantised average spatial direction value can be used in the generation of the comfort noise for the SID frame of the SID interval and in all subsequent zero frames of the SID interval. Furthermore, the quantised average spatial direction value received may be in the form of a spherical direction value, therefore when received in this form they can be used directly to generate the comfort noise signal for the SID frame and subsequent zero frames.

The step of generating the comfort noise by the spatial metadata decoder 1109 operating in non-prediction mode is shown as the processing step 1007 in FIG. 10.

Returning to step 1001, should the processing of the step indicate that the spatial metadata decoder 1109 is required to operate in a prediction mode of operation the process may proceed to step 1005. At step 1005 the spatial metadata decoder 1109 may be arranged to determine whether the SID frame received is the first SID frame of a silence region or whether the SID frame is a first frame of a further SID interval within the silence region. If it is determined that the SID frame received at the decoder is the first SID frame of a silence region then the spatial metadata decoder 1109 may proceed to execute the processing step 1009. In other words, the spatial metadata decoder 1109 operates in the first SID interval prediction mode for the zero frames of the SID interval.

Recall, that the received SID frame may contain the quantised average spatial direction value for the first frame of the SID interval. In some embodiments these may be sent to the decoder in the form of a quantised spherical direction value. So initially the spatial metadata decoder 1109 may be configured to transform the quantised average spherical direction value to the cartesian coordinate system. As previously explained above this may be performed using the equations (1), (2) and (3) above.

As explained above when the spatial metadata decoder 1109 operates in the first SID interval prediction, mode backward prediction can used to provide a predicted spatial direction value for each zero frame of the SID interval. This can be performed by using the backward predictor according to equation (4). Where the prediction coefficients b₁(k) and b₀(k) can be found using least mean square analysis over a data set of past average quantized direction values for a number of previous audio frames before the start of the first SID frame of the first SID interval. In effect the same data set as used at the encoder.

The backward predictors at the decoder may also be initialised with the quantised average spatial direction value sent as part of the metadata set for the first SID frame. In this case the predicted spatial direction value for the first zero frame may be given by equation (5), and the subsequent predicted spatial direction value for the second zero frame maybe given by equation (6). The backward prediction step, as similarly described at the encoder, is also performed for each of the cartesian coordinates to give xₑₛₜ(k, m), yₑₛₜ(k, m) and zₑₛₜ(k, m) for each zero frame of the SID interval. As before all prediction may be performed on a per sub band basis k.

Returning to step 1005 the spatial metadata decoder 1109 may determine that the SID frame received is a SID update frame, that is a SID frame of a SID interval which is not the first SID interval of a silence region. In this case the spatial metadata decoder 1109 may proceed to execute the processing step 1011. In other words, the spatial metadata decoder 1109 operates in the non-first SID interval prediction mode for the zero frames of the upcoming SID interval.

When operating in a non-first SID interval prediction mode, the spatial metadata decoder 1109 may use the method of linear interpolation between two points to determine predicted spatial direction values for the zero frames of the SID interval. As previously explained for the encoder, the spatial metadata decoder 1109 may take the received quantised average spatial direction value from the previous SID frame and the received quantised spatial direction value from the current SID frame and perform a linear interpolation between the two points. The linear interpolation may then be extrapolated across the zero frames of the current SID interval. The predicted spatial direction value for each zero frame may then be given as the corresponding point along the extrapolated linear prediction. As before, this form of prediction can be performed for each of the spatial direction cartesian coordinates in turn to provide the xₑₛₜ(k, m), yₑₛₜ(k, m) and zₑₛₜ(k, m) for each zero frame of the SID interval. Similarly, all prediction may be performed on a per frequency band basis k.

It is to be noted that this particular method of prediction may store the quantised average spatial direction values for the current SID frame in order that they can be used for prediction for the next SID interval.

Following both prediction methods, each of the predicted cartesian coordinates xₑₛₜ(k, m), yₑₛₜ(k, m) and zₑₛₜ(k, m) for each zero frame may be transformed to their respective spherical direction components ϕₑₛₜ(k, m) and θₑₛₜ(k, m). In embodiments this transformation may be performed by

$${ϕ}_{est} ( k , m ) = atan \frac{{y}_{e s t} ( k , m )}{{x}_{e s t} ( k , m )}$$

$${θ}_{est} ( k , m ) = atan \frac{{Z}_{e s t} ( k , m )}{\sqrt{{{x}_{est} ( k , m )}^{2} + {{y}_{est} ( k , m )}^{2}}}$$

where function a tan is the arc tangent that automatically detects the correct quadrant for the angle.

Note in a manner similar to the spatial metadata encoder 409, the spatial metadata decoder 1109 may also be arranged to operate directly using the spherical coordinates as the spatial direction value. In these embodiments the backward predictors at the decoder may also be initialised with the quantised average spatial spherical direction value sent as part of the metadata set for the first SID frame. The backward prediction steps as described above, may be performed for directly each of the spatial spherical direction values to give ϕₑₛₜ(k, m), and θₑₛₜ(k, m) for each zero frame of the SID interval. As before all prediction may be performed on a per sub band basis k.

The spherical direction component value of each zero frame (whether they are found by one of the prediction methods or whether they are as a result of the non-prediction method) and the spherical direction component value of the SID frame may then be used by subsequent processing stages to generate a comfort noise signal across the frames of the of the SID interval.

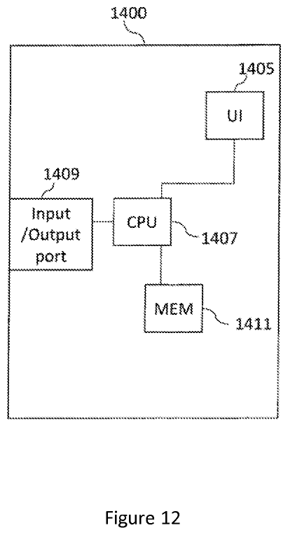

With respect to FIG. 12 an example electronic device which may be used as the analysis or synthesis device is shown. The device may be any suitable electronics device or apparatus. For example, in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example, the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore, the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein and generate a suitable audio signal format output by using the processor 1407 executing suitable code.

The input/output port 1409 may be coupled to any suitable audio output for example to a multi-channel speaker system and/or headphones or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs can route conductors and locate components on a semiconductor chip using well established rules of design as well as libraries of pre-stored design modules. Once the design for a semiconductor circuit has been completed, the resultant design, in a standardized electronic format may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-48. (canceled)

49. An apparatus comprising at least one processor and at least one memory including computer program code, the at least one memory and the computer program code configured to, with the at least one processor, cause the apparatus to:
determine an error of fit measure between a plurality of spatial direction component values from a plurality of audio frames and a curve fitted to a data set comprising the plurality of spatial direction component values;
compare the error of fit measure to a threshold value;
quantise a spatial direction component value for a first audio frame of an interval of audio frames to give a quantised spatial direction component value for the first audio frame; and
depending on the comparison, either use a method of non-prediction for generating at least one spatial direction component value for each remaining audio frame of the interval of audio frames, or use a method of prediction for generating the at least one spatial direction component value for each remaining audio frame of the interval of audio frames, wherein all remaining audio frames comprise all but the first audio frame of the interval of audio frames.

50. The apparatus as claimed in claim 49, wherein the method of non-prediction for generating the at least one spatial direction component value for each remaining audio frame of the interval of audio frames causes the apparatus to:
store the quantised spatial direction component value of the first audio frame for use as a previous quantised spatial direction component value.

51. The apparatus as claimed in claim 49, wherein the method of prediction for generating the at least one spatial direction component value for each remaining audio frame of the interval of audio causes the apparatus to:
determine whether the interval of audio frames is a first interval of audio frames of a silence region of the spatial audio signal or whether the interval of audio frames is a further interval of audio frames of the silence region of the spatial audio signal.

52. The apparatus as claimed in claim 51, wherein when the interval of audio frames is determined as the first interval of audio frames of the silence region of the spatial audio signal, the apparatus is further caused to:
determine the coefficients of a backward predictor using a data set comprising a plurality of quantised spatial direction component values drawn from the plurality of audio frames;
initialise the backward predictor with the quantised spatial direction component value for the first audio frame of the interval of audio frames; and
use the backward predictor to predict the at least one spatial direction component value for each remaining audio frame of the first interval of audio frames of the silence region.

53. The apparatus as claimed in claim 52, wherein the backward predictor is a first order backward predictor, and wherein the coefficients of the backward predictor are determined using least mean square analysis of the data set comprising the plurality of average spatial direction component values drawn from the plurality of audio frames.

54. The apparatus as claimed in claim 52, wherein when the interval of audio frames is determined as the further interval of audio frames of the silence region of the spatial audio signal, the apparatus is further caused to:
use linear interpolation to interpolate between the quantised spatial direction component value for the first audio frame of the further interval of audio frames of the silence region and a previous quantised spatial direction component value for a first audio frame from a previous interval of audio frames of the silence region;
extrapolate the linear interpolation to extend over remaining audio frames of the further interval of audio frames; and
assign at least one value from along the extrapolated part of the liner interpolation for each remaining audio frame of the further interval of audio frames, wherein the assigned at least one value is the at least one spatial direction component value for the each remaining audio frame of the further interval of audio frames.

55. The apparatus as claimed in claim 49, wherein the apparatus configured to determine an error of fit measure between a plurality of spatial direction component values from the plurality of audio frames and the curve fitted to a data set comprising the plurality of spatial direction component values is configured to:
perform least mean squares analysis on the data set comprising the plurality of spatial direction component values to find coefficients for a polynomial for curve fitting to the data set;
determine for each spatial direction value of the plurality of spatial direction component values an error value between the each spatial direction component value and a point of the curve fitted to the data set; and
determine the error of fit measure as the root mean square of the error values.

56. The apparatus as claimed in claim 55, wherein the polynomial for curve fitting to the data set is a first order polynomial.

57. The apparatus as claimed in claim 54, wherein the curve fitted to the data set comprising the plurality of spatial direction component values is the linear interpolation between the quantised average spatial direction component value for the first audio frame of the further interval of audio frames of the silence region and a previous quantised average spatial direction component value for the first frame from the previous interval of audio frames of the silence region, wherein the plurality of spatial direction component values are original spatial direction components values for the previous interval of audio frames, wherein the apparatus caused to determine an error of fit measure between a plurality of spatial direction values from a plurality of audio frames and a curve fitted to a data set comprising the plurality of spatial direction values is caused to:
determine for each spatial direction value of the plurality of spatial direction component values an error value between the each spatial direction component value and a point along the is the linear interpolation; and
determine the error of fit measure as the root mean square of the error values.

58. The apparatus as claimed in claim 49, wherein the first audio frame of the interval audio frames comprises a plurality of subframes, wherein each of the plurality of subframes comprises a spatial direction component value and wherein the spatial direction component value is an average spatial direction component value comprising the mean of the plurality of subframe spatial direction component values, and the quantised spatial direction component value is a quantised average spatial direction component value.

59. The apparatus as claimed in claim 49, wherein a spatial direction component value is related to a spatial direction parameter, wherein the spatial direction parameter comprises an azimuth component and an elevation component, and wherein the spatial direction component value is one of:
an x-cartesian component transformed from the azimuth component and elevation component;
a y-cartesian component transformed from the azimuth component and elevation component; and
a z-cartesian component transformed from the azimuth component and elevation component.

60. The apparatus as claimed in claim 49, wherein the plurality of audio frames comprises audio frames prior to the first audio frame of the interval of audio frames.

61. The apparatus as claimed in claim 49, wherein the plurality of audio frames comprises the first audio frame of the interval of audio frames and audio frames prior to the first audio frame of the interval of audio frames.

62. The apparatus as claimed in claim 49, wherein the determination of use of prediction or non-prediction is signalled as a 1-bit flag.

63. The apparatus as claimed in claim 49, wherein the interval of audio frames is a silence descriptor (SID) interval.

64. An apparatus comprising at least one processor and at least one memory including computer program code, the at least one memory and the computer program code configured to, with the at least one processor, cause the apparatus to:
receive a quantised spatial direction component value for a first audio frame of an interval of audio frames;
determine whether to use a method of non-prediction for generating at least one spatial direction component value for each remaining frame of the interval of audio frames, wherein all remaining audio frames comprise all but the first audio frame of the interval of audio frames; and
determine whether to use a method of prediction for generating at least one spatial direction component value for each remaining frame of the interval of audio frames, wherein all remaining audio frames comprises all but the first audio frame of the interval of audio frames.

65. The apparatus as claimed in claim 64, wherein the method of non-prediction for generating a spatial direction component value for each remaining frame of the interval of audio frames causes the apparatus to:
use the received quantised spatial direction component value for the first audio frame of the interval of audio frames as at least one spatial direction component value for each of the remaining frames of the interval of audio frames.

66. The apparatus as claimed in claim 64, wherein the method of prediction for generating the at least one spatial direction component value for each remaining frame of the interval of audio frames causes the apparatus to:
determine whether the interval of audio frames is a first interval of audio frames of a silence region of the spatial audio signal or whether the interval of audio frames is a further interval of audio frames of the silence region of the spatial audio signal.

67. The apparatus as claimed in claim 66, wherein when the interval of audio frames is determined as the first interval of audio frames of the silence region of the spatial audio signal, the apparatus is further caused to:
determine coefficients of a backward predictor using a data set comprising a plurality of quantised spatial direction component values drawn from a plurality of audio frames;
initialise the backward predictor with the quantised spatial direction component value for the first audio frame of the interval of audio frames; and
use the backward predictor to predict the at least one spatial direction component value for each remaining frame of the first interval of audio frames of the silence region.

68. The apparatus as claimed in claim 67, wherein the backward predictor is a first order backward predictor, and wherein the coefficients of the backward predictor are determined using least mean square analysis of the data set comprising the plurality of quantised spatial direction component values drawn from the plurality of audio frames.

69. The apparatus as claimed in claim 66, wherein when the interval of audio frames is determined as the further interval of audio frames of the silence region of the spatial audio signal, the apparatus is further caused to:
use linear interpolation to interpolate between the quantised spatial direction component value for the first audio frame of the further interval of audio frames of the silence region and a previous quantised spatial direction component value for a first audio frame from a previous interval of audio frames of the silence region;
extrapolate the linear interpolation to extend over remaining audio frames of the further interval of audio frames; and
assign at least one value from along the extrapolated part of the liner interpolation for each remaining audio frame of the further interval of audio frames, wherein the assigned at least one value is the at least one spatial direction value for the each remaining audio frame of the further interval of audio frames.

70. The apparatus as claimed in claim 64, wherein the apparatus configured to determine use of the method of prediction or non-prediction is further configured to:
receive a flag signalling the use of prediction or non-prediction; and
read the received flag.

71. The apparatus as claimed in claim 64, wherein a spatial direction component value is related to a spatial direction parameter, wherein the spatial direction parameter comprises an azimuth component and an elevation component, and wherein the spatial direction component value is one of:
an x-cartesian component transformed from the azimuth component and elevation component;
a y-cartesian component transformed from the azimuth component and elevation component; and
a z-cartesian component transformed from the azimuth component and elevation component.

72. The apparatus as claimed in claim 64, wherein the interval of audio frames is a silence descriptor (SID) interval.
